(19) United States
(12) Patent Application Publication
(10) Pub. No.: US 2004/0167966 A1
(43) Pub. Date: Aug. 26, 2004

(54) Method and system for directing communications in a communications network

(76) Inventors: Simon Lee, Boston, MA (US); Benoit Vandevivere, Tilly Capelle (FR)

Correspondence Address: BAKER & MCKENZIE, 805 THIRD AVENUE, NEW YORK, NY, 10022, US

(21) Appl. No.: 10/782,426

(22) Filed: Feb. 18, 2004

Related U.S. Application Data
(60) Provisional application No. 60/449,000, filed on Feb. 21, 2003.

(51) Int. Cl. G06F 15/16

(52) U.S. Cl. 709/206; 713/201

(57) ABSTRACT

The present application in one aspect discloses a method and system for directing communications in a communications network using a non-unique receiver identifier that allows users to forego the unique receiver identifier (such as electronic mail address), for a simpler, non-unique, alphanumeric address (a name, or number or a combination of both). The method enables an initiator to direct communication to a particular receiver by using a non-unique custom-defined receiver identifier as part of the communication process. The service provider system residing on the communications network retrieves the non-unique receiver identifier from the initiator and maps the non-unique receiver identifier to the corresponding receiver's unique identifier by accessing a stored user record that pertains to the specific initiator. The service system then directs the communication to this unique identifier of the receiver and completes the communication.

### CROSS-REFERENCE TO RELATED APPLICATIONS

This application claims the benefit of U.S. Provisional Patent Application No. 60/449,000, entitled METHOD AND SYSTEM FOR DIRECTING COMMUNICATIONS IN A COMMUNICATIONS NETWORK filed on Feb. 21, 2003, which application is incorporated herein by reference in its entirety.

### TECHNICAL FIELD

The present application generally relates to a method and system for directing communications in a communications network and more particularly to directing communications via a communications network using a non-unique receiver identifier.

### BACKGROUND

As communication networks become more and more complex, people feel an increasing need to remember certain key information in such a manner that the information is easy to recall and ready to access when needed. Unfortunately, people are frequently unable to remember and recall information without assistance. The communication identifiers like addresses used in modern electronic mail messaging or even phone numbers are a case in point. There are some inherent issues with these artificial, counter-intuitive and unnatural sounding names, numbers, identifiers and addresses that are prevalent today. These identifiers are usually assigned by a third party or a service provider like in the case of phone numbers. Due to the significant proliferation in the number of users of such services, the requested identifiers may not be available as the identifier might already exist. Sometimes the user's actual name might be difficult to pronounce and remember due to differences in culture, race or geographical location. These problems are compounded when a user decides to change the service provider due to geographical or professional relocation or when the user decides to change over or extend to another communications device. It might even be the case that a particular communications identifier might become invalid or not actively used because of exceeding the prescribed limits of service. This is commonly observed in electronic mail services when the user account exceeds the maximum allowed storage limit. Such a situation may require a user to migrate to alternative services or accounts for temporary or permanent relief. There are also instances when the format of the communications identifier like electronic mail addresses for example might undergo drastic changes in the naming convention, due to merger of companies or service expansion. Given these scenarios, the frustration of the user is only understandable. And quite regrettably, all these continue to be the norm today across most communications media in general, and especially in electronic mail communications in spite of it being one of the largest utilized services on the Internet. Increasingly high number of these convoluted and largely incoherent communications identifiers and messaging addresses are created in the observed format for purely technical reasons and system constraints. A direct consequence of this is the imposed addition of extra alphabets or numbers or special characters to make a requested identifier unique. Throughout the electronic world, billions of electronic mails and numerous other forms of electronic communications are exchanged every day in this, time consuming, inflexible format. These result in countless hours of invaluable cognitive and physical effort expended towards storing and searching communication identifiers such as electronic mail addresses. As a result, there is an unprecedented reliance on a range of third-party memory aids such as address books in the form of personal digital assistants, electronic mail clients, web-based email services and sometimes just plain paper, as a temporary measure, to help keep track of these obscure communications identifiers. This dependency on third party tools also means that a temporary or permanent loss or unavailability of this service, for one reason or the other, would result in cumulative cost damages due to delayed, misspelled, misaddressed, unfulfilled or lost communications.

Accordingly, what is desired is an improvement in the efficiency of usage of communication identifiers like electronic mail addresses by millions of users around the world who constantly need to identify the receiver over a communications network. It is therefore apparent that a need exists for a method and system whereby the receiver identifiers (addresses) may be conveniently redefined and renamed by the initiator. It is also apparent that a need exists for a method whereby the initiator and the receiver identifiers (addresses) may be automatically and efficiently maintained. Further, a solution to the above-identified problem needs to be a viable alternative for use across a range of communication networks and protocols. Accordingly, the present disclosure in one aspect addresses such a need.

### SUMMARY OF THE INVENTION

A method and system for directing communications in a communications network using a non-unique receiver identifier is provided. The communications network, for example, may be an electronic medium that has at least one initiator of the communication, one receiver and at least one ‘non-unique receiver identifier’-enabled communications service provider.

In one aspect, the method and system of the present application allows users of the system to save significantly on the cognitive and physical effort in remembering, recalling and retrieving communication identifiers (like electronic mail addresses) by identifying the intended receivers of a communication by employing a simple, non-unique alphanumeric, custom-defined identifier eliminating the need for a complicated, hard-to-remember, communications identifier with a rigid format, like the electronic mail address.

In another aspect, receivers may be located quickly and efficiently in the communications network, because the ubiquitous service provider network automatically directs communications to the corresponding unique receiver's identifier (e.g. electronic mail address) pointed based on the non-unique receiver identifier provided by the initiator.

In yet another aspect, when a user changes his/her unique communications identifier (e.g. electronic mail address), a method in the present application allows the updating of this change across all of the other related users, who have requested to be connected to the initiator as illustrated in FIG.7.

In one aspect, this application allows the initiator and the receiver to protect their privacy by rendering directed communications to remain partially anonymous at any given instance in the communication process, for example, by using non-unique identifiers for communications. This eliminates the conventional risk of a third party identifying the association of the initiator and the receiver without access to the information recorded in the service provider system.

It is noted that throughout the specification and claims the term “user” encompasses any entity, for example, a human, that operates a communications device and/or terminal such as a computer, a phone, a personal digital assistant, wireless device, television-based system or just about any device through which a message may be sent, for example, for the purpose of connecting to and communicating via a communications network with another user who acts as a receiver. From time to time, the term “user” may also refer to a registered user of the ‘non-unique receiver identifier’-enabled communications service provider network. It is further noted that the term “initiator” refers to the originator of a communication and is not necessarily limited to a single human user. Similarly, the term “receiver” refers to the recipient of any transmitted communication and is not necessarily limited to a single human user or a single non-human recipient of the communication. In general, the term “users” may include a group of initiators and/or receivers who use the communications network.

Accordingly, the present application in one aspect provides a method and system that enables an initiator to direct communications to a particular receiver by indicating a non-unique receiver identifier as part of the communication. The non-unique receiver identifier enables users to identify specific receivers in the communications domain by using a simple, non-unique alphanumeric identifier (a name or number or a combination of both) that the user remembers and naturally associates with the specific user. Unlike a complicated and rigidly formatted electronic mail address, this identifier may be used by any number of other users to describe any number of other receivers in their contextual environment. A non-unique receiver identifier may be unique in the set of identifiers associated with the user, and does not necessarily need to be non-unique.

In one aspect, a service provider system residing on the communications network includes one or more elements such as the server engine, the client repository and the mapping repository. The service system retrieves the non-unique receiver identifier, as described above, from the initiator and identifies the particular user record that pertains to the particular initiator. The service system then maps the non-unique receiver identifier in the user record to the corresponding unique identifier of the receiver. The service system then directs the communication to this stored unique identifier of the receiver and completes the communication process. The service system receives and stores information about identified and registered users in user records that may be accessed at a later time to retrieve the matching unique identifiers based on a given non-unique receiver identifier.

In another aspect, the present application provides a communications network system with multiple channels including electronic mail, voice, SMS, or wireless media.

In one aspect, the present disclosure provides a method of creating a non-unique receiver identifier across multiple channels including electronic mail, voice, SMS and wireless media. In another aspect, the present disclosure provides a method of directing communications wherein a change in the unique identifier of any user of the service is updated on all user records that point to the unique identifier of the user. Yet in another aspect, the present disclosure provides a method of directing communications wherein a single initiator uses multiple non-unique identifiers to represent a single unique receiver. Further in another aspect, the present disclosure provides a method of directing communications wherein multiple related or unrelated unique users use multiple non-unique identifiers to represent a single common receiver. In another aspect, the present disclosure provides a method of directing communications wherein multiple unique users use a single non-unique receiver identifier to represent a single unique receiver. In another aspect, the present disclosure provides a method of directing communication wherein multiple unique users use a single non-unique receiver identifier to communicate with multiple unique receivers. In another aspect, the present disclosure provides a method of directing communications wherein multiple unique users use a single non-unique receiver identifier to communicate with a group of related multiple unique receivers. Further yet, the present disclosure in one aspect provides a method of directing communications wherein the communications are rendered partially anonymous at any given instance of the communication process, thereby eliminating the risk of a third party associating a unique initiator with a unique receiver.

The present application in another aspect may be implemented to enable a cross-linking between the unique communications identifiers of two related users of the service as to enable the update of the new unique identifier if there is a change in the existing unique identifier of either of the users. This implementation may also ensure multiple updates of all other users pointing to this user's existing unique communications identifier.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates an example method of creating a non-unique receiver identifier in one embodiment of the present application.

FIG. 2 is a diagram illustrating a creation of a non-unique receiver identifier in one embodiment of the present application.

FIG. 3 is a diagram illustrating a processing of a non-unique receiver identifier-enabled communication through a communications network in one embodiment of the present application.

FIG. 4 is a block diagram illustrating system components in one embodiment of the present application.

FIG. 5 is a flow diagram illustrating a method of enabling the creation of a non-unique receiver identifier in one embodiment.

FIG. 6 is a flow diagram illustrating a method implementing a routine that processes a non-unique receiver identifier-enabled communication in one embodiment.

FIG. 7 is a flow diagram illustrating a method of processing the updating of a user's unique identifier in one embodiment.

FIG. 8 is a diagram illustrating a communication interaction between a single initiator and a single receiver via a communications network by employing multiple non-unique receiver identifiers in one embodiment.

FIG. 9 is a diagram illustrating a communication interaction between multiple initiators and multiple receivers via a communications network by employing a single common non-unique receiver identifier in one embodiment.

FIG. 10 is a diagram illustrating a communication interaction between a single initiator and multiple receivers in a receiver group via a communications network by employing a single non-unique receiver identifier for the entire group in one embodiment.

FIG. 11 is a diagram illustrating a communication interaction between a single initiator with multiple unique identifiers and a single receiver via a communications network by employing a single non-unique receiver identifier in one embodiment.

FIG. 12 is a diagram illustrating the process of establishing a non-unique receiver identifier-enabled communication through a communications network in one embodiment of the present application wherein the communication is rendered partially anonymous at any given instance in the communication process.

FIG. 13 is a flow diagram illustrating a method of the service provider system that maintains the non-unique receiver identifier mapping in one embodiment.

FIG. 14 is a flow diagram that illustrates a method of obtaining the receiver's new unique identifier in one embodiment of the present application as described in 1302 in FIG. 13, wherein the receiver's new unique identifier is untraceable.

FIG. 15 is a flow diagram that illustrates a method of authenticating a user in one embodiment of the present application as indicated in 1303 in FIG. 13.

FIG. 16 is a diagram illustrating a processing of a non-unique identifier-enabled communication by the service provider system in one embodiment.

FIG. 17 is a diagram illustrating a processing of a non-unique identifier-enabled communication by the service provider system in one embodiment, wherein a user may opt-out of future communications from other users.

FIG. 18-19 are examples of communication paths in one embodiment.

### DETAILED DESCRIPTION

The present application in one aspect provides a method and system for directing communications using a non-unique receiver identifier in a communications network. The non-unique receiver identifier in one aspect enables users to identify a particular receiver through any non-unique alphanumeric name that the user may think of and remember. Unlike the current, rigidly-formatted electronic mail addresses (e.g., robert_duvall1997@mailserviceprovider.domainname), this non-unique receiver identifier may be used by any number of users to describe any number of other receivers in their contextual environments. A service provider system of the present disclosure in one aspect retrieves the initiator's unique identifier and processes the communication by directing it to the actual initiator-intended receiver by mapping the non-unique receiver's identifier indicated by the initiator to the corresponding unique receiver identifier of the receiver.

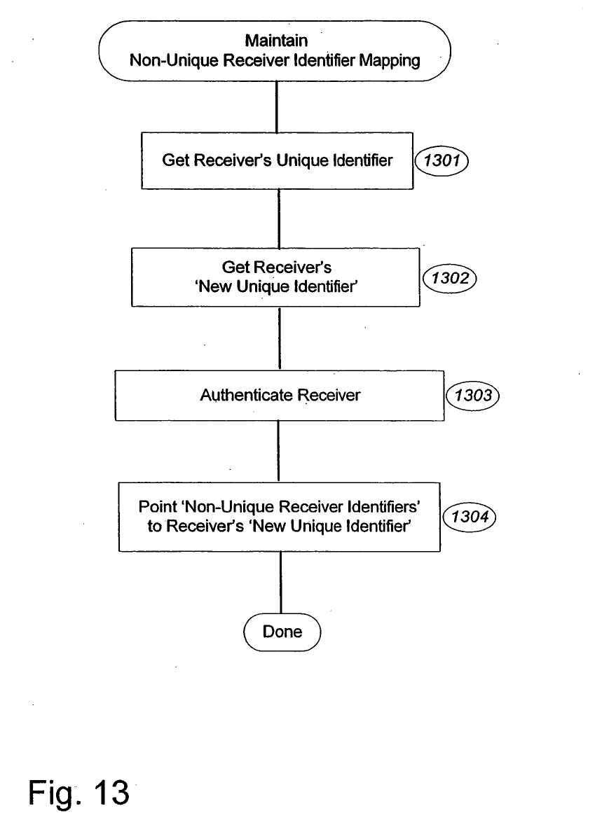

The present application in one embodiment also allows two users to remain connected by linking their corresponding non-unique receiver identifiers to their unique communication identifiers as illustrated in FIG. 13. This linking allows the users to continue using their respective non-unique receiver identifiers regardless of possible changes or updates to either of their unique communication identifiers. One skilled in the art would appreciate that the above processes defined as part of the application in one aspect may be rearranged or adapted in various ways. In general, the user need only be aware of the custom-defined non-unique receiver identifier used to enable the communication.

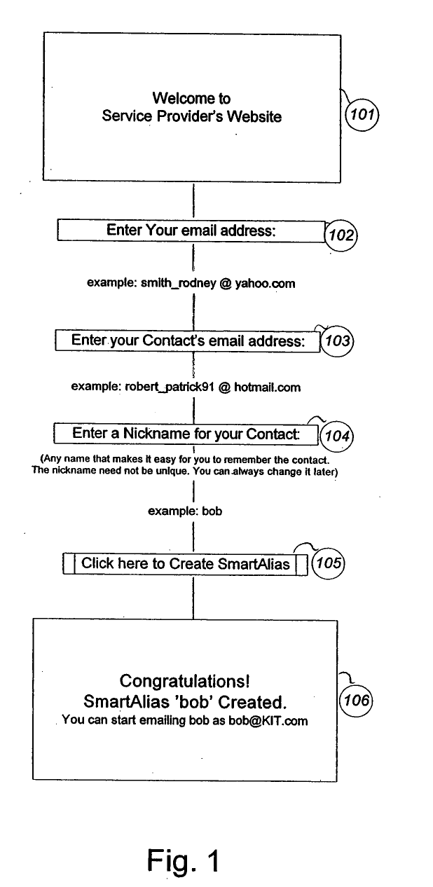

FIG. 1 illustrates the creation of a non-unique receiver identifier in one embodiment of the present application. 101 is an illustration of a web page welcoming a user to the service provider web site. This example web page was sent from the server system to the client system when the user requested a service offered by a service provider. This example web page contains a request for entering the user's unique identifier 102 which is the user's electronic mail address, a request for entering the receiver's unique identifier 103 which is the receiver's electronic mail address and a request for entering the non-unique receiver identifier 104. The non-unique receiver identifier enables users to identify the particular receiver by substituting the unique receiver identifier with a non-unique alphanumeric name, for example, that is easy for the user to remember. Unlike a rigidly formatted electronic mail address, this identifier may be used by any number of other users to describe any number of other receivers in their contextual environment. In one embodiment, the non-unique receiver identifier is unique to the user who creates it and is not necessarily non-unique. In other words, a user creates a unique, non-repeating set of non-unique identifiers for the related set of receivers. The non-unique identifier may also be created so as to refer to more than one unique user. That is, many users of the service may use the same non-unique receiver identifier to refer to a specific receiver. Conversely, a user may create multiple non-unique receiver identifiers for a particular receiver having one unique receiver identifier also. One skilled in the art would appreciate that these sections may be omitted or rearranged or adapted in various ways. Once the user submits the request 105, the non-unique receiver identifier is created with a confirmation message 106, unless the service provider system takes some action to modify or retry the request depending on the availability of the non-unique receiver identifier.

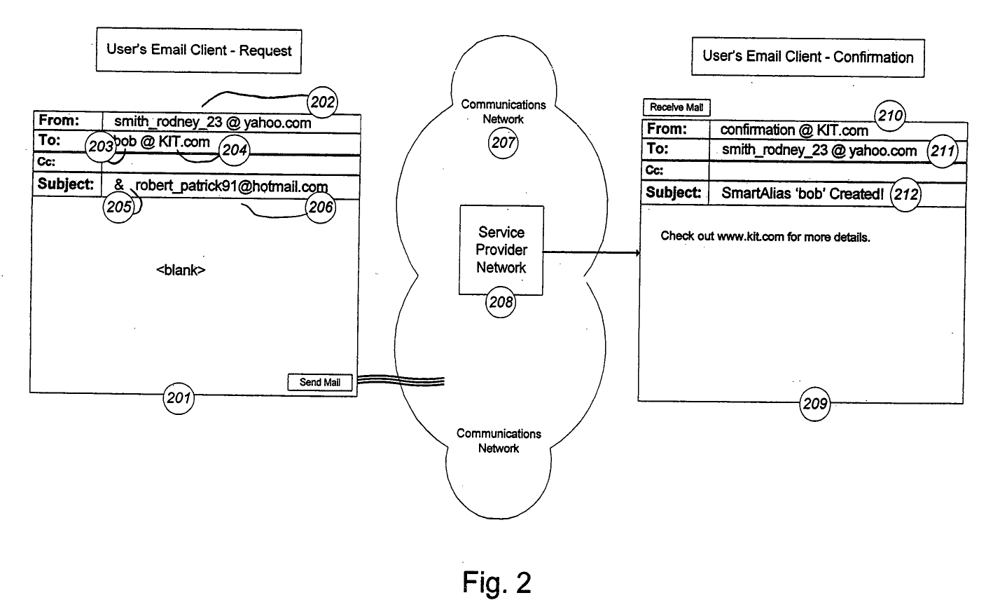

Reference is now made to FIG. 2, which illustrates the creation of a non-unique receiver identifier in one embodiment of the present application. 201 is the user's mail client with the fields populated with example data. 202 is the user's unique identifier. 203 is the requested non-unique receiver identifier that is not necessarily non-unique to the user. The non-unique receiver identifier enables users to identify the particular receiver through any non-unique alphanumeric name that the user may imagine. Unlike an electronic mail address, this identifier may be used by any number of other users to describe any number of other receivers in their contextual environment. The non-unique receiver identifier may be unique to the user who creates it and need not necessarily be non-unique. In other words, a user creates a unique, non-repeating set of non-unique identifiers for the related set of receivers. The non-unique identifier may also be created so as to refer to more than one unique user. That is, many users of the service may use the same non-unique receiver identifier to refer to a specific receiver. Conversely, a user may create multiple non-unique receiver identifiers for a particular receiver having one unique receiver identifier also. 204 is an identifier for the service provider providing the service. By using this identifier 204, the communication or email in this case is directed to the service provider.

205 is a request type identifier as defined by the service provider network. The request type identifier in one aspect is a keyboard character typed in by the user in the subject line of the electronic mail client. If an electronic mail received by the service provider contains the specific keyboard character in the subject line, then the service provider identifies that electronic mail as a request for creation of a non-unique receiver identifier and obtains the unique receiver identifier from the subject line to process the request for creating a non-unique receiver identifier.

206 is a receiver's unique identifier as entered by the user. The submission of this communication through a suitable communications network 207 is accessed by the service provider network 208 that resides in the communications network. 209 is the user's electronic mail client with a service confirmation message received by the user. 210 is an electronic mail address of the service provider. 211 is a user's unique identifier. 212 is a subject line that confirms the creation of a non-unique receiver identifier for the specific receiver. One skilled in the art would appreciate that these various sections may be omitted or rearranged or adapted in various ways.

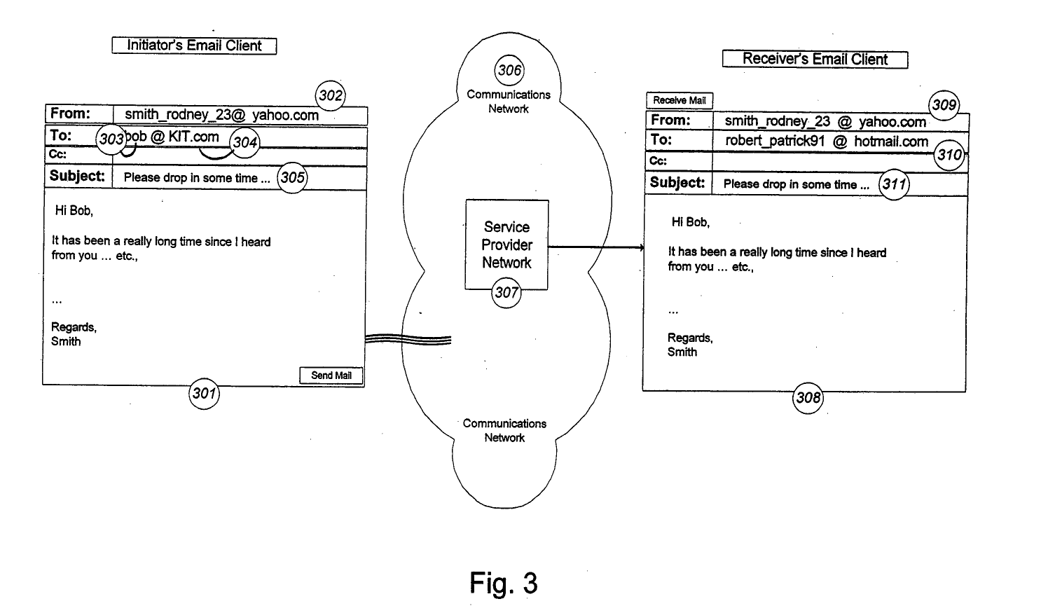

Reference is now made to FIG. 3, which illustrates processing a non-unique receiver identifier-enabled communication through a communications network in one embodiment of the present application. 301 is an illustration of an electronic mail client of an initiator of a non-unique receiver identifier-enabled communication. 302 is a unique identifier of the initiator of the communication. 303 is a non-unique receiver identifier previously created by the initiator that is not necessarily non-unique. 304 is an identifier for a service provider who offers this service. 305 is a subject line that contains a personal message for the receiver as preferred by the initiator. Once submitted to the communications network 306, the service provider network 307 that resides on the communications network processes the communication by directing it to the receiver. 308 is an illustration of a receiver's electronic mail client. 309 is the unique identifier of the sender. 310 is the receiver's unique identifier that has been retrieved from a particular initiator's record by the service provider. 311 is the same personal subject line as previously typed in by the initiator in the electronic mail client 301. One skilled in the art would appreciate that these various sections may be omitted or rearranged or adapted in various ways. In general, the user need only be aware of the custom-defined non-unique receiver identifier that is used to enable the communication.

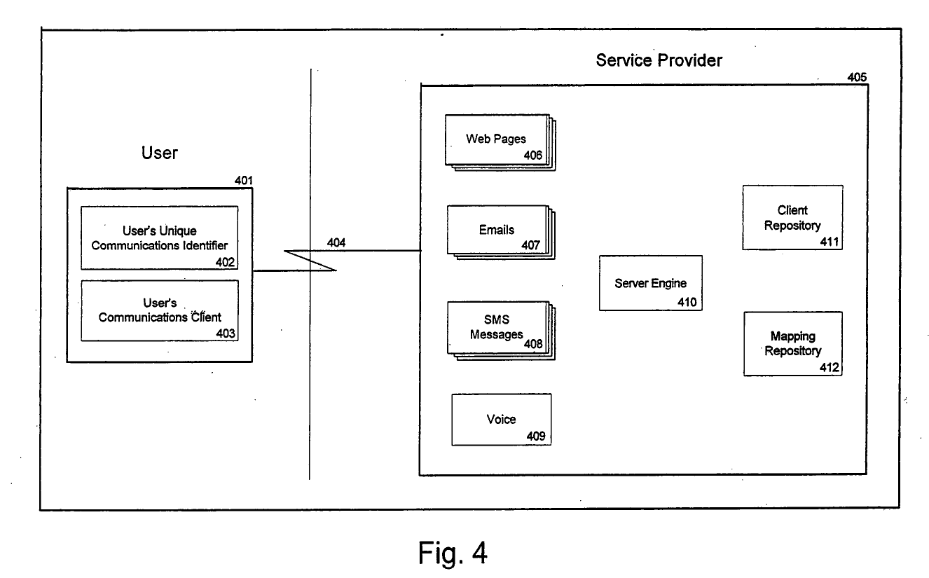

Reference is now made to FIG. 4, which is a block diagram illustrating an embodiment of the present application in one aspect. This embodiment supports the non-unique receiver identifier over the Internet using the electronic mail client application. The user system 401 comprises of a user's unique identifier 402 and a user's communications client 403. The communications network 404 directs the user to the service provider system 405.

The service provider system 405 in one embodiment includes various web pages 406, various electronic mails 407, various SMS text messages 408, various voice communications 409, a server engine 410, client repository 411, mapping repository 412, etc. The server engine 410 retrieves the communication from the initiator and directs the communication to the intended receiver's unique address. Such an action has indicated that initiator 401 has used non-unique receiver identifier to initiate the communication to the intended receiver.

The client repository 411 includes user information such as communications identifiers, which are unique communications identifiers that represent the initiator's unique identity. The unique communications identifiers may include electronic mail addresses, mobile phone numbers, and additional information related to just about any communications device through which a message may be sent. The client repository 411 may also include information such as the name of the user, login and password information.

The mapping repository 412 maps each user to a corresponding non-unique receiver identifier, which uniquely represents the receiver from the initiator's perspective. The initiator's identifier is assigned by third-party providers such as electronic mail service provider, telecommunication carrier operator, wireless service provider, etc. The initiator uses any of the unique initiator identifiers to establish a communication with other users by using a non-unique receiver identifier. When the initiator initiates a communication, the information of the communication includes the initiator's unique identifier and non-unique receiver identifier, so the server system may identify the source of the message and retrieve the corresponding receiver's unique identifier. The server system may then look up or search for the receiver's identifier to direct the communication appropriately.

One skilled in the art would appreciate that the non-unique receiver identifier-enabled communication processing technique may be used in various environments not limited to the Internet. For example, a non-unique receiver identifier-enabled communications directing may also be provided in a SMS text message communication 408. Also, various communication channels may be used such as local area network, wide area network, or point-to-point dial up connection. It may be noted that a server system may comprise any combination of hardware or software for directing a communication in response to the non-unique receiver identification being performed. A user's client system 403 may comprise any combination of hardware or software for interacting with the server system. For instance, the user's client systems described herein may include just about any device through which a message may be sent. One skilled in the art would appreciate that these various sections may be omitted or rearranged or adapted in various ways.

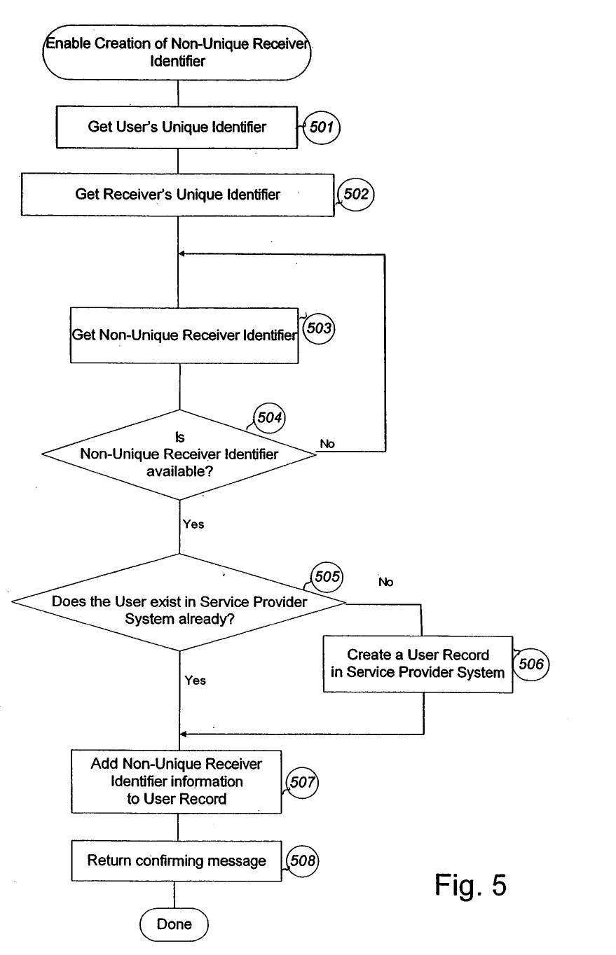

Reference is now made to FIG. 5, which is a flow diagram illustrating one embodiment of enabling the creation of a non-unique receiver identifier. In step 501, the service provider system gets the user's unique identifier. In step 502, the service provider system gets the receiver's unique identifier. In step 503, the service provider system gets the non-unique receiver identifier for the receiver. The service provider system may obtain this information in various ways depending on the communication medium and the service implementation that is involved. The non-unique receiver identifier enables users to identify a particular receiver through any non-unique alphanumeric name that the user may imagine. Unlike a conventional, rigidly formatted electronic mail address, this identifier may be used by any number of other users to describe any number of other receivers in their contextual environment.

In one aspect, the non-unique receiver identifier is unique to the user who creates it and is not necessarily non-unique. In other words, a user creates a unique, non-repeating set of non-unique identifiers for the related set of receivers. The non-unique identifier may also be created so as to refer to more than one unique user. That is, many users of the service may use the same non-unique receiver identifier to refer to a specific receiver. It is also possible for a user to create multiple non-unique receiver identifiers for a particular receiver having one unique receiver identifier.

In step 504, the service system continues to step 505 if, for example, the proposed non-unique receiver identifier is uniquely available in the particular user's record. In step 505, the service system checks for the existence of a record for the user and continues to step 507 if a record exists, else the service system creates a new record for the user in step 506. In step 507, the service system adds the non-unique receiver identifier to the particular user's record, which will link the submitted non-unique receiver identifier to the user's unique identifier. In step 508, the service system returns a confirmation of the successful creation of a non-unique receiver identifier and completes. It will be appreciated by persons skilled in the art that various features of the above process which are, for clarity, described in the context of separate embodiments may also be provided in combination in a single embodiment. Conversely, various features of the above process which are described in the context of a single embodiment may also be provided separately or in any suitable combination. For instance, the user systems described herein may include just about any device through which a message may be sent.

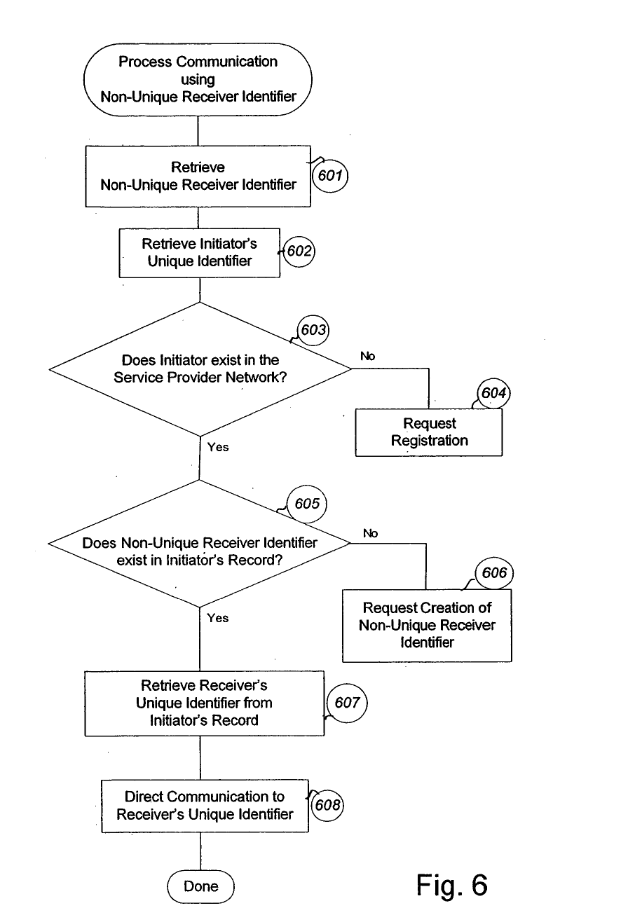

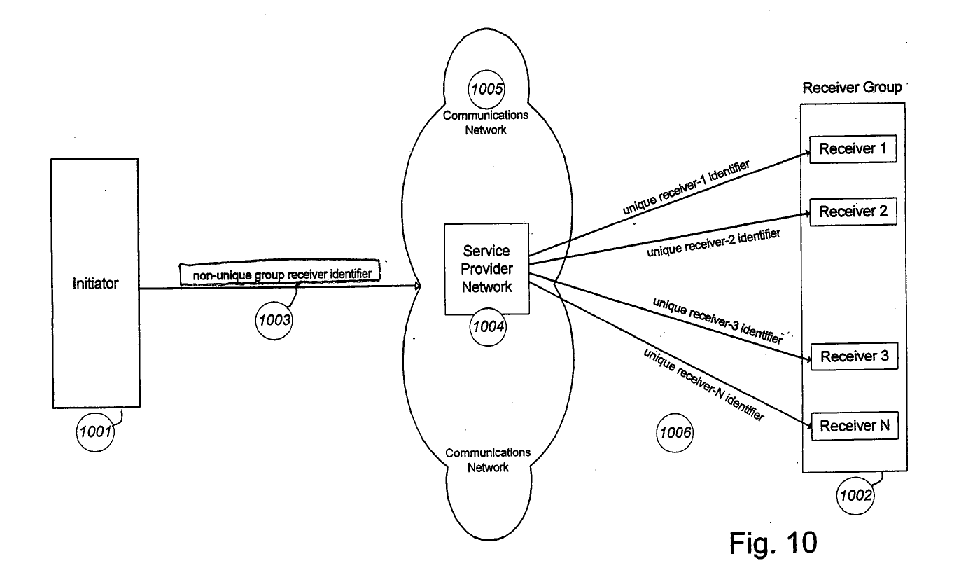

Reference is now made to FIG. 6, which is a flow diagram in one embodiment of processing a non-unique receiver identifier-enabled communication. In step 601, the service provider system retrieves the non-unique receiver identifier. In step 602, the service provider system retrieves the initiator's unique identifier. In one embodiment, the non-unique receiver identifier is unique to the user who creates it. A single non-unique identifier may also be created for use by more than one unique initiator. That is, many users of the service may use the same non-unique receiver identifier to refer to a specific receiver. Conversely, a user may create multiple non-unique receiver identifiers for a particular receiver having one unique receiver identifier also. It is also possible in the present application in one aspect to create a single non-unique identifier that may be functionally accessed by a group of initiators with individual unique identifiers and to define the non-unique receiver identifier to represent a group of receivers as explained in FIG. 10.

The service provider system may obtain this information in various ways depending on the communication medium and the actual service implementation that is involved. In step 603, the service system verifies the existence of the initiator anywhere in the service provider network and continues to step 605 if the initiator exists, else the initiator is requested to register with a service provider system in step 604. In step 605, the service system verifies the existence of the non-unique receiver identifier in the initiator's record and continues to step 607 if the non-unique receiver identifier exists, else the communication is returned to the initiator requesting creation of a non-unique receiver identifier in step 606.

In step 607, the service provider system secures access to the initiator's record and retrieves the particular receiver's unique identifier that corresponds to the receiver's non-unique receiver identifier that was initially retrieved in step 601. In step 608, the service provider system directs the communication from the initiator to the receiver's unique identifier and completes. It will be appreciated by persons skilled in the art that various features of the above process which are, for clarity, described in the context of separate embodiments may also be provided in combination in a single embodiment. Conversely, various features of the above process which are described in the context of a single embodiment may also be provided separately or in any suitable combination. For instance, the user systems described herein may include just about any device through which a message may be sent.

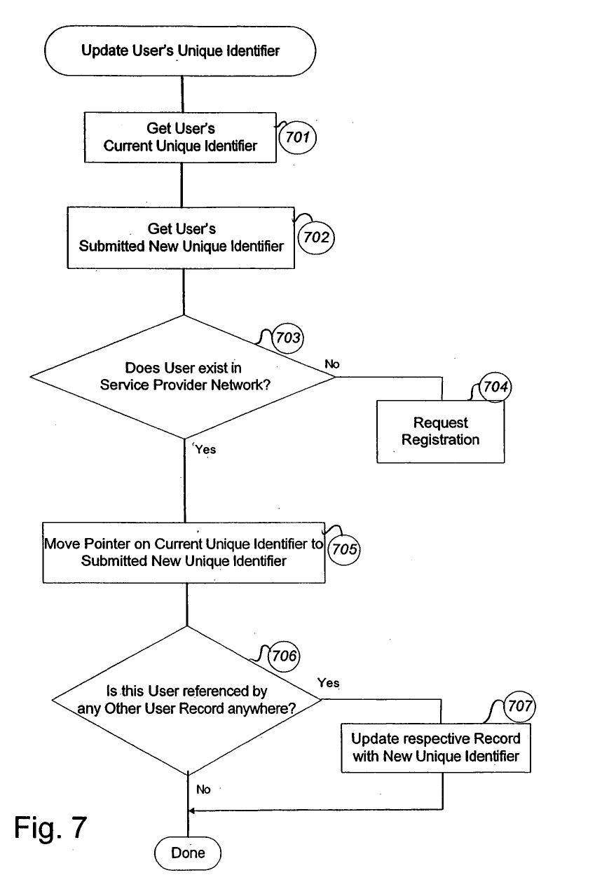

Reference is now made to FIG. 7, which illustrates a flow diagram in one embodiment of updating a user's unique identifier. In step 701, the service provider system gets the user's current unique identifier. In step 702, the service provider system gets the submitted new unique identifier for the user. The service provider system may obtain this information in various ways depending on the communication medium and the actual service implementation that is involved. In step 703, the service provider system verifies the existence of the user in the service provider network and continues to step 705 if the user exists, else the user is requested to register with the service provider network in step 704.

In step 705, the service provider system moves the pointer currently pointing to the existing unique identifier of the user to the new unique identifier submitted in step 702. In step 706, the service system verifies if the user considered in step 701 is pointed by any other user record anywhere in the service provider network and continues to complete action if there are no references to the user anywhere in the service provider network, else the service system continues with step 707 to update all the other user records that reference this user and completes.

The method described with reference to FIG. 7 may be used, for example, if a user changes his or her unique identifiers, such as email addresses, etc. It will be appreciated by persons skilled in the art that various features of the above process, which are, for clarity, described in the context of separate embodiments, may also be provided in combination in a single embodiment. Conversely, various features of the above process which are described in the context of a single embodiment may also be provided separately or in any suitable combination. For instance, the user systems described herein may include just about any device through which a message may be sent.

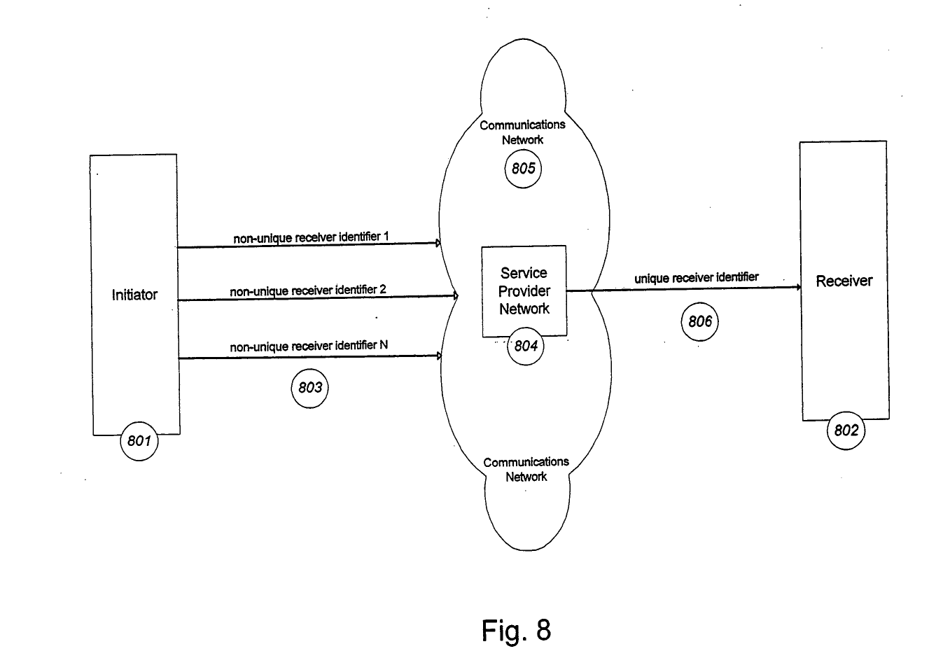

Reference is now made to FIG. 8, which is a diagram illustrating a communication interaction between a single initiator and a single receiver via a communications network by employing multiple non-unique receiver identifiers in one embodiment. In a communication interaction between a single initiator 801 and a single receiver 802, it is possible as an embodiment of the present application in one aspect to enable multiple non-unique receiver identifiers as indicated in 803, with every one of these identifiers defining the relationship between the same single initiator and the same single receiver.

During a typical interaction, each of the non-unique receiver identifiers when processed by the service provider network 804 residing on the communications network 805 is matched to the same unique receiver identifier 806 to reach the same single receiver 802. It is also possible in the present application in one aspect to enable multiple initiators to communicate with a single receiver by using multiple non-unique receiver identifiers. It will be appreciated by persons skilled in the art that various features of the above process which are, for clarity, described in the context of separate embodiments may also be provided in combination in a single embodiment. Conversely, various features of the above process which are, for brevity, described in the context of a single embodiment may also be provided separately or in any suitable combination. For instance, the user systems described herein may include just about any device through which a message may be sent.

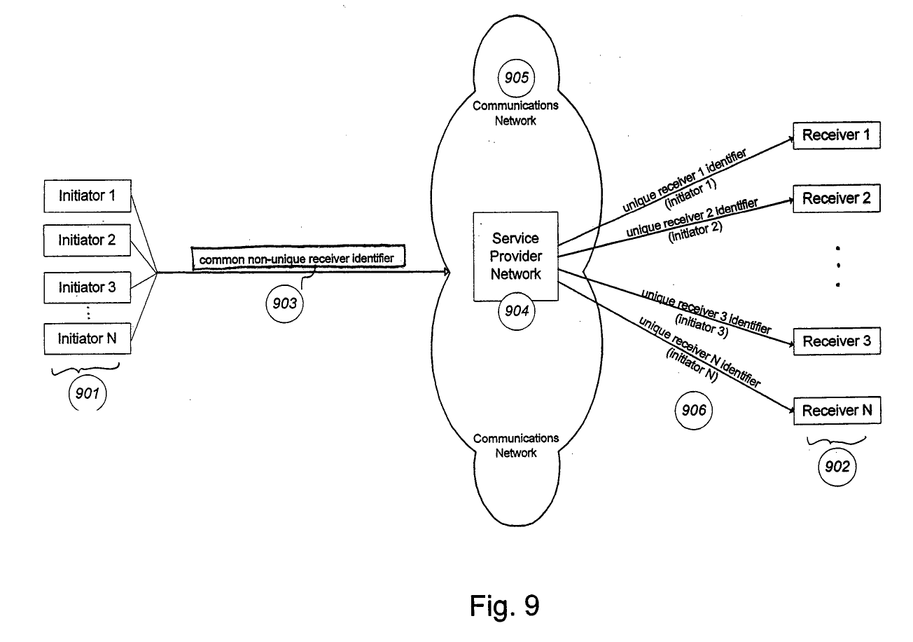

Reference is now made to FIG. 9, which is a diagram illustrating a communication interaction between multiple initiators and multiple receivers via a communications network by employing a single common non-unique receiver identifier in one embodiment. During a typical interaction, each of the initiators 901 communicates with the corresponding set of receivers 902 by using the same non-unique receiver identifier 903. This communication is then processed by the service provider network 904 residing on the communications network 905 to be mapped to the corresponding multiple unique receiver identifiers 906 to reach the individual receivers as indicated in 902.

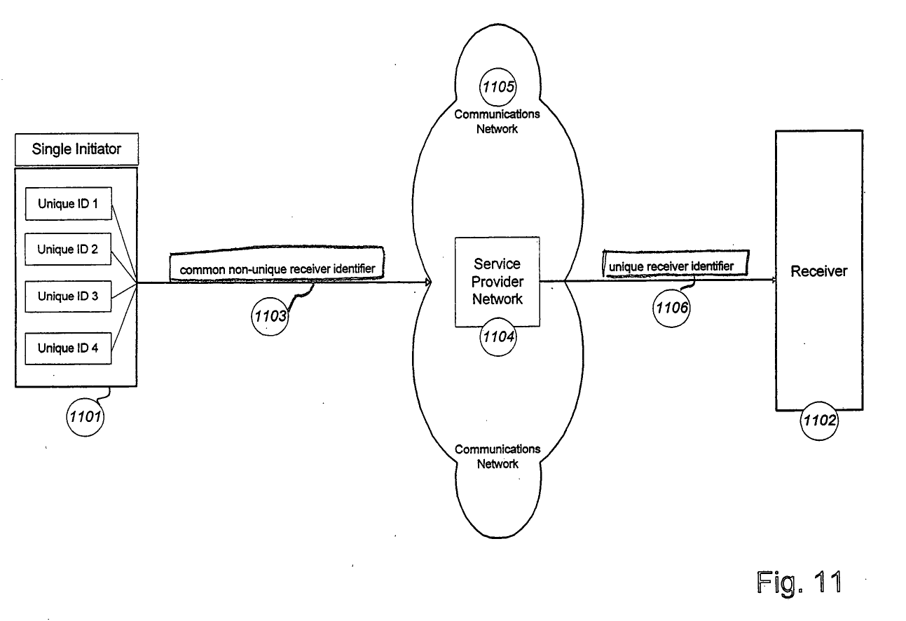

In one embodiment, the multiple initiators may be a set of disparate users or a single user operating from several uniquely identified addresses, as indicated in FIG. 11. It will be appreciated by persons skilled in the art that various features of the above process which are, for clarity, described in the context of separate embodiments may also be provided in combination in a single embodiment. Conversely, various features of the above process which are described in the context of a single embodiment may also be provided separately or in any suitable combination. For instance, the user systems described herein may include just about any device through which a message may be sent.

Reference is now made to FIG. 10, which is a diagram illustrating a communication interaction between a single initiator and multiple receivers in a receiver group via a communications network by employing a single non-unique receiver identifier for the group in one embodiment. During a typical interaction, the initiator 1001 communicates to a group of receivers as indicated in 1002 by using a single non-unique group receiver identifier 1003. This communication is then processed by the service provider network 1004 residing on the communications network 1005, which then maps the communication by using unique receiver identifiers 1006 to reach the corresponding set of unique receivers in the receiver group 1002. It will be appreciated by persons skilled in the art that various features of the above process which are, for clarity, described in the context of separate embodiments may also be provided in combination in a single embodiment. Conversely, various features of the above process which are described in the context of a single embodiment may also be provided separately or in any suitable combination. For instance, the user systems described herein may include just about any device through which a message may be sent.

Reference is now made to FIG. 11, which is a diagram illustrating a communication interaction between a single initiator with multiple unique identifiers and a single receiver via a communications network by employing a single common non-unique receiver identifier in one embodiment. During a typical interaction, the initiator 1101 communicates from any one or all of the range of multiple unique identifiers (addresses) that the initiator 1101 uses to establish communication with a single receiver 1102 by using a single non-unique receiver identifier 1103. This communication is then processed by the service provider network 1104 residing on the communications network 1105, which then maps all the individual unique identifiers of the initiator to the single unique receiver identifier 1106 to reach the unique receiver 1102, irrespective of the origin of the communication from the initiator. It will be appreciated by persons skilled in the art that various features of the above process which are, for clarity, described in the context of separate embodiments may also be provided in combination in a single embodiment. Conversely, various features of the above process which are described in the context of a single embodiment may also be provided separately or in any suitable combination. For instance, the user systems described herein may include just about any device through which a message may be sent.

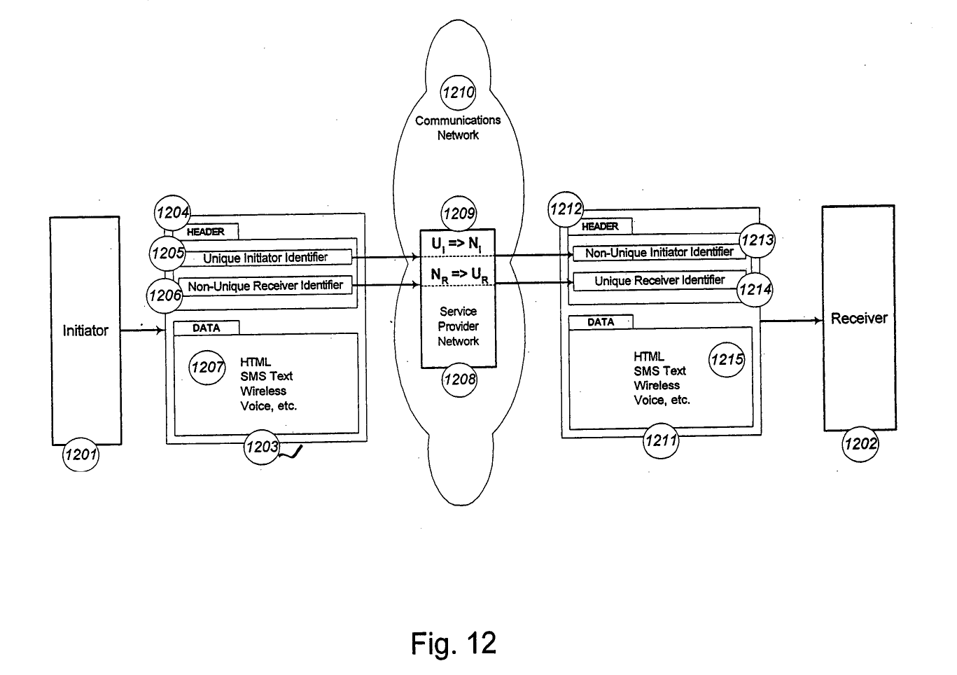

Reference is now made to FIG. 12, which is a diagram illustrating establishing of a non-unique receiver identifier-enabled communication through a communications network in one embodiment of the present application. During a typical interaction, the initiator 1201 communicates with the receiver 1202. The initiator's communication 1203 includes a communications header 1204 comprising a unique initiator identifier 1205 and a non-unique receiver identifier 1206. 1207 is an example of the data content of the communication which may be HTML or SMS text or voice or wireless content, or just about any kind of data that may be directed through a communications medium. This communication 1203 is retrieved by the service provider network 1208 residing on the communications network 1210. The service provider system 1208 modifies the header information of the communication by re-mapping the unique initiator identifier (Uᵢ) to the corresponding non-unique initiator identifier (Nᵢ) and re-mapping the non-unique receiver identifier (N_{R}) to the corresponding unique receiver identifier (U_{R}) as indicated in 1209. This results in a modification in the communications header information at the receiver's client 1212 by replacing the unique initiator identifier 1205 with the non-unique initiator identifier 1213 and replacing the non-unique receiver identifier with the unique receiver identifier 1214. 1215 is an example of the communications data received by the receiver's communications client.

One embodiment of this application may allow an increase in privacy through partial anonymity of the communication at a given instance in the communications process. That is, at a given point in the communications process, a third party provided with the header information of this communication may not be able to identify more than one participant user of the communications process at the same time. The partial anonymity may also allow two users who are aware of each other's unique identifiers to receive a communication that identifies the initiator simply by the previously defined non-unique identifier itself, thereby dispensing with the use of unique identifiers at the receiver's end.

This provides for receivers to receive a communication with the initiator's identifier redefined the way the receiver wants it by proactively replacing the unique identifiers in the communication headers with the previously-defined non-unique identifiers. The present application in one embodiment may also allow users to increase the privacy of their communications by remaining anonymous in the role of an initiator or a receiver by revealing only the non-unique identifier to the other user, thereby ensuring that he initiates or receives a communication without revealing the unique communications identifier.

It is possible in the present disclosure in one embodiment for an initiator to opt out of further communications from the respective user by disabling and discontinuing the link between the non-unique identifier and the unique identifier. It is also possible for a receiver to opt out of further communication from a potential initiator by doing the same. The method and system of the present application may apply not just for electronic mail communications but also for voice, SMS, wireless and just about any communications device through which a message may be sent. It will be appreciated by persons skilled in the art that various features of the application which are, for clarity, described in the context of separate embodiments may also be provided in combination in a single embodiment. Conversely, various features of the application which are described in the context of a single embodiment may also be provided separately or in any suitable combination. For instance, the user's client systems described herein may include just about any device through which a message may be sent.

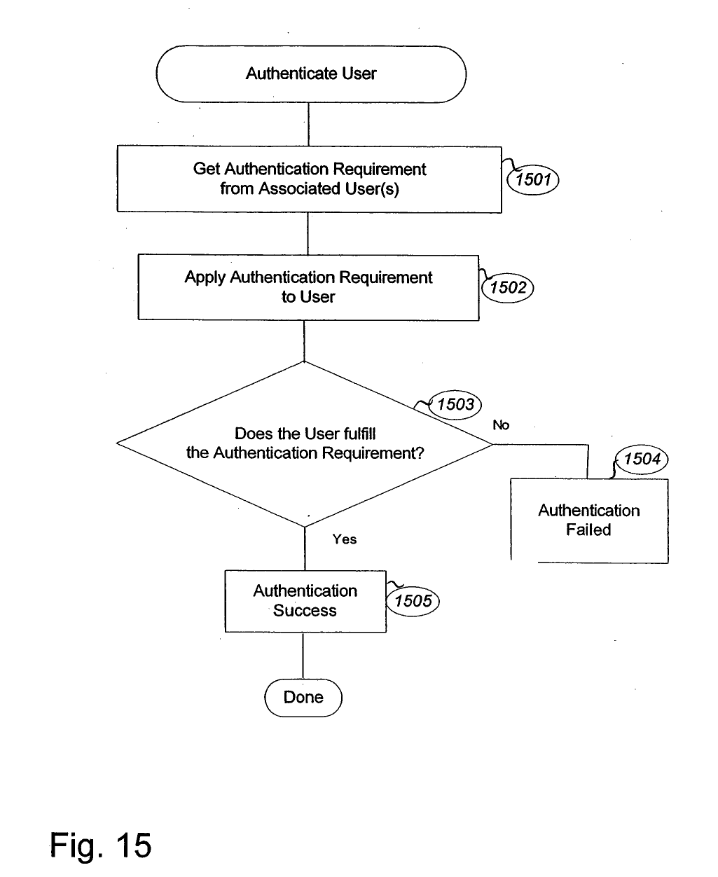

Reference is now made to FIG. 13, which is a flow diagram illustrating a method of a service provider system that maintains the non-unique receiver identifier mapping in one embodiment. In step 1301, the service provider system gets the receiver's unique identifier. In step 1302, the service provider system gets the receiver's new unique identifier. In step 1303 the service provider system authenticates the receiver by communicating with the new unique receiver identifier obtained through step 1302. The receiver authentication may be effected in several ways as may be determined by the service provider network. One embodiment of this authentication process is illustrated in FIG. 15. Once the receiver is authenticated, the service provider system in step 1304 points the non-unique receiver identifiers to the receiver's new unique identifier and maintains the non-unique receiver identifier mapping.

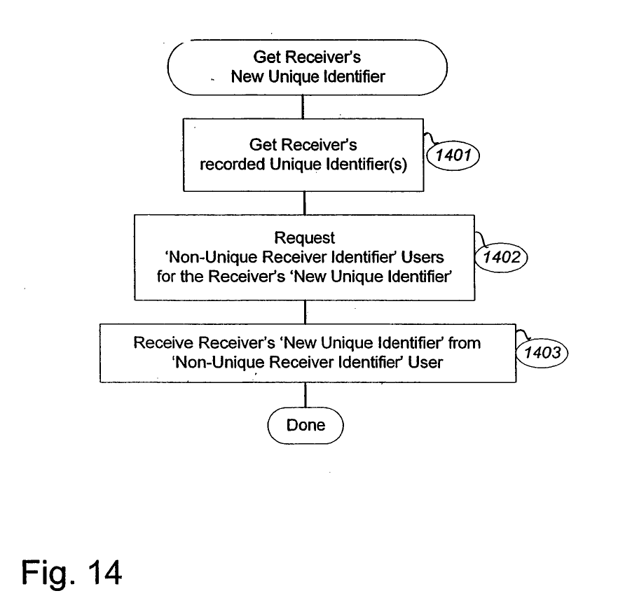

In one aspect, the receiver's unique identifier obtained in step 1301 may include one or several unique identifiers and may be valid across more than one communication network and communication media, all of which may be updated together or selectively as the case may be. One embodiment of step 1302, wherein the receiver's new unique identifier is untraceable for various reasons, is illustrated in FIG. 14. In one aspect, the non-unique identifiers indicated in step 1304 may not include all the non-unique identifiers associated with the unique receiver identifier. It will be appreciated by persons skilled in the art that the various elements of the above process which are, for clarity, described in the context of separate embodiments may also be provided in combination in a single embodiment. Conversely, various elements of the above process which are described in the context of a single embodiment may also be provided separately and in any order and in any suitable combination. For instance, the identifiers described herein may be valid for just about any communications device through which a message may be sent.

Reference is now made to FIG. 14, which is a flow diagram illustrating a method of obtaining the receiver's new unique identifier in one embodiment of the present application as described in 1302 in FIG. 13, wherein the receiver's new unique identifier is untraceable, for example, because the receiver changed his or her unique identifier. In step 1401, the service provider system gets the receiver's recorded unique identifier(s) stored in the client repository 411. In step 1402, a message is sent from the service provider system to the users of the non-unique receiver identifier, requesting them to inform the service provider network of the whereabouts of the particular receiver, for example, by providing the receiver's new unique identifier to the system. In step 1403, the service provider system receives the information requested in step 1402 from one or many of the non-unique identifier users who are associated with, for example, communicates with this particular receiver, and completes. It may be noted that, the receiver's recorded unique identifier(s) indicated in step 1401 may include one or more than one active or inactive communications identifiers for the particular receiver, all of which were previously stored in the particular receiver's record during the history of the receiver's association with the service provider network.

The following example illustrates one embodiment described with reference to FIG. 14. User A, B, and C have registered to the communications service described in the present disclosure. Both users A and B have a non-unique receiver identifier defined for user C, in this example, an email nickname that is mapped to user C's unique email address. Sometime later, for example, a few years later, user A uses the non-unique receiver identifier to communicate to C. However, user C in the meantime has changed his unique email address, but did not inform the communications service, and thus the non-unique receiver identifier that is linked to user C's old email address does not work. The system and method of the present disclosure in this case may ask every user having a link to user C for user C's latest email address, that is, user C's unique identifier. For example, the system and method asks user B, who provides user C's new email address. The system and method of the present disclosure then attempts to contact user C using this new email address, authenticates the new email address, and updates user C's record in the system.

The ‘non-unique receiver identifier’ users indicated in step 1402 are users of the service provider network who have associated themselves with the receiver, by registering a non-unique identifier for a particular receiver. It may be noted that these users may or may not have had prior communication with the receiver through their non-unique receiver identifiers. In one aspect, users may submit one or more than one new unique receiver identifier which would then be authenticated. This receiver authentication may be effected in several ways as may be determined by the service provider network. One embodiment of this authentication process is illustrated in FIG. 15. It will be appreciated by persons skilled in the art that the various elements of the above process which are, for clarity, described in the context of separate embodiments may also be provided in combination in a single embodiment. Conversely, various elements of the above process which are described in the context of a single embodiment may also be provided separately and in any order and in any suitable combination. For instance, the identifiers described herein may be valid for just about any communications device through which a message may be sent.

Reference is now made to FIG. 15, which is a flow diagram that explains a method of authenticating a user in one embodiment of the present application as indicated in 1303 in FIG. 13. In step 1501, the service provider system gets the authentication requirement from one or several users of the service provider network who is associated to this particular user. This authentication requirement is then communicated to the user in step 1502 with a request to confirm authenticity. Step 1503 verifies to determine if the user fulfills the authentication requirement and proceeds to step 1504 if the user fulfills the requirement successfully, else it fails the user authentication in step 1504. Step 1505 authenticates the user and completes the routine. In one aspect, the authentication requirement indicated in 1501 is user specific and may be defined by the associated user.

In one aspect, the service provider network provides a platform for the authentication process whereby other users may verify and confirm the identity of the particular user. Accordingly, in this aspect, the details of the authentication requirement such as any specific questions and answers, etc., as created by the other user are communicated to the particular user, without needing to be stored by the service provider system. Any authentication requirement is therefore fresh and from the user of the service provider network who is associated to this particular user, and may be individually responsible for creating the authentication requirement and verifying this particular user's authenticity.

This embodiment of the present application, therefore, allows users to authenticate just about any other user of the service provider network whose genuine identity is in doubt. In one aspect, the verification process as indicated in 1503 may be done manually or automatically, individually or as a group depending on the type of service implementation defined by the service provider and/or by the user. In another aspect, the authentication process may at times involve a process much beyond a generic process, such as the one performed in the case of a user's lost password. It may, for instance, be a more specific authentication of the user's new unique identifier also. It will be appreciated by persons skilled in the art that the various elements of the above process which are, for clarity, described in the context of separate embodiments may also be provided in combination in a single embodiment. Conversely, various elements of the above process which are described in the context of a single embodiment may also be provided separately and in any order and in any suitable combination.

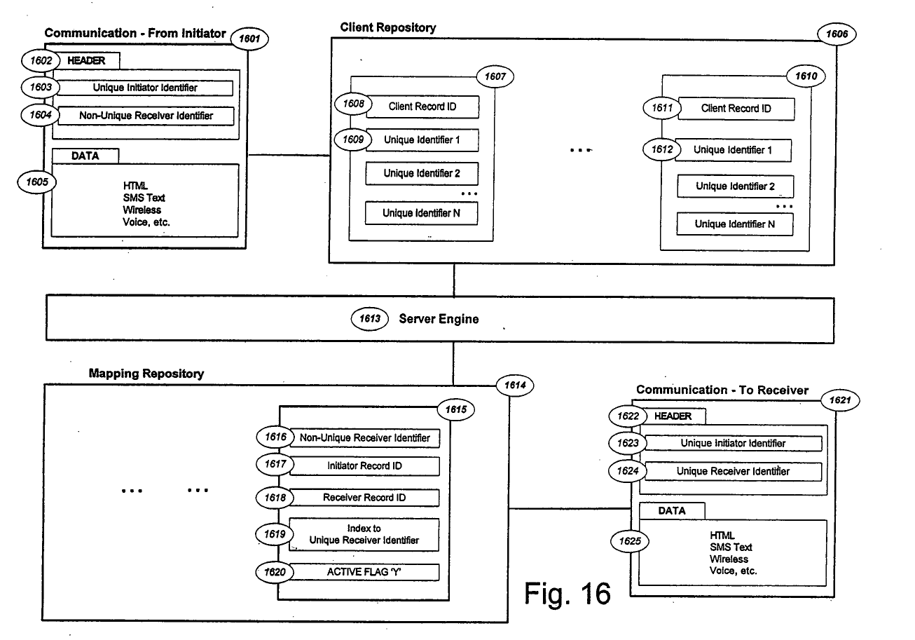

Reference is now made to FIG. 16, which is a diagram illustrating the processing of a non-unique identifier-enabled communication by the service provider system in one embodiment. 1601 is a non-unique identifier-enabled communication originated by the initiator. The header 1602 of this communication includes a unique initiator identifier 1603 and a non-unique receiver identifier 1604.

In one aspect, the header information may contain other relevant information such as the service provider identifier. 1605 is a message body of the communication which may take the form of an electronic mail message, SMS text, wireless message or voice telephony, as the case may be. 1606 is the client repository which may include the client records 1607, 1610.

In one aspect, the client records stored in the client repository are maintained independent of the specific roles of the user. In other words, a client record pertains generally to the user of the service provider system and not specifically to his role as a receiver or an initiator and may not necessarily be created by the specific user. In one embodiment, each of the client records 1607, 1610 comprises a client record ID 1608 and a list of all the unique identifiers that are owned by a user.

It may be noted that the client records 1607, 1610 may comprise one or more unique identifiers depending on the user preferences. The term “client record” refers in general to each unique entry in the client repository 1606 and does not necessarily refer to a container of all the information associated with a user as this may be available in other parts of the service system such as the mapping repository 1614.

In one aspect, every client record in the client repository is linked to at least one mapping record in the mapping repository in order to complete the information required to direct the communication to the receiver. The server engine 1613 manages the processing of the communication by interfacing with the different components of the service provider system.

The mapping repository 1614 stores the mapping records 1615 that contains the parameters and the linking information that enable the mapping process. In one embodiment, the mapping record 1615 contains the non-unique receiver identifier 1616, the client record ID of the initiator 1617, the client record ID of the receiver 1618, and an index to the unique receiver identifier 1619 that is stored in the specific client record that contains the receiver's record ID 1618.

In one embodiment, a single mapping record 1615 maintains the linking information 1619, for example, an index that maps one unique client record 1607 in the client repository to another client record 1610. In one aspect, the mapping record may include other parameters or linking information depending on the service implementation such as the active flag 1620. 1621 is a representation of the communication that is directed to the receiver, which includes the header 1622, which may further include the unique initiator identifier 1623 and the recovered unique receiver identifier 1624. 1625 is the communication message body that is directed to the receiver.

During a typical interaction, the server engine 1613 receives the communication 1601, originated by the initiator that contains the header information 1602, which includes a non-unique receiver identifier 1604 and the unique initiator identifier 1603. Using the unique initiator identifier 1603 the server engine 1613 then locates the specific client record 1607 that contains the same particular unique initiator identifier 1609, and retrieves the initiator's client record ID 1608 from the record 1607. Based on the non-unique receiver identifier 1604 and the retrieved initiator's client record ID 1608, the server engine 1613 locates the specific mapping record 1615 in the mapping repository 1614, and retrieves the client record ID 1611 of the receiver and the index 1619 to the specific unique receiver identifier.

The server engine 1613 then locates the particular client record 1610 that contains the receiver's client record ID 1611 and retrieves the unique identifier 1612 of the receiver as indexed by 1619. The server engine then directs the communication 1621 to the receiver as indicated by the recovered unique receiver identifier 1612.

As depicted, the communication 1621, sent from the server engine 1613 and originated by an initiator, includes header information, which may comprise a unique initiator identifier 1623 and a unique receiver identifier 1624 as well as other information such as 1625, which may resemble the information 1605. Those skilled in the art would appreciate that the header information 1622 may also comprise a non-unique initiator identifier in place of the unique initiator identifier 1623 as depicted in the above embodiment. It would also be appreciated by those skilled in the art that an initiator does not need the intended receiver's effort to provide information to the service provider system prior to initiating communication using the non-unique receiver identifier. In other words, the receiver need not be aware of the service system or the service provider or even the initiator, to be able to receive a non-unique identifier-enabled communication from the initiator. In such a case, information pertaining to both the initiator and receiver may be sourced from the initiator itself.

In one aspect, the client records 1607, 1610 and others maintained in the client repository 1606 do not indicate the specific role of the user and are stored independent of whether the user plays the role of an initiator or a receiver and are created based on the unique identifiers of the user provided at the time of service registration or service usage as the case may be. Further, although the client repository and the mapping repository were described with respect to certain data fields and records, the data contained in these repositories need not be limited to only those shown and described. Thus, other data or information may be stored in the repositories.

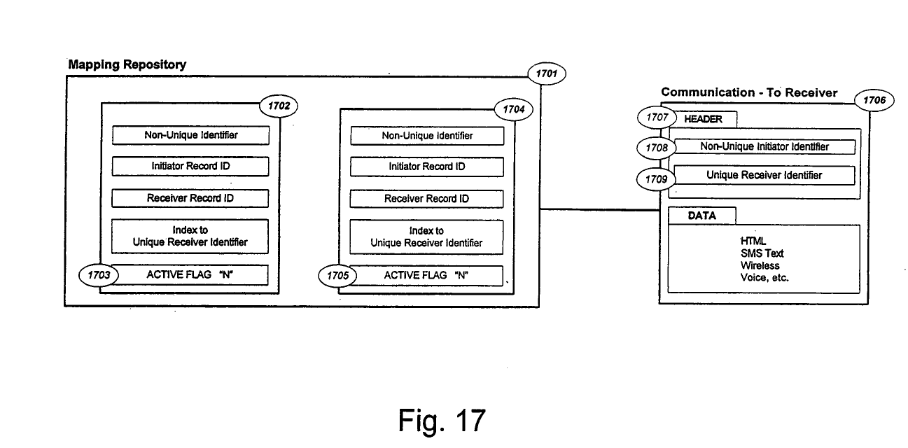

One embodiment of the present application that describes the processing of a non-unique identifier-enabled communication wherein a user may opt-out of future communication from other users is illustrated in FIG. 17. It will be appreciated by persons skilled in the art that the various elements of the above process which are, for clarity, described in the context of separate embodiments may also be provided in combination in a single embodiment. Conversely, various elements of the above process which are described in the context of a single embodiment may also be provided separately and in any order and in any suitable combination.

Reference is now made to FIG. 17, which is a diagram illustrating a processing of a non-unique identifier-enabled communication by the service provider system wherein a user may opt-out of future communications from other users. In this embodiment, the header information 1707 comprises of a non-unique initiator identifier 1708 in place of unique initiator identifier 1623 as depicted in FIG. 16. As will be described in greater detail herein, the unique receiver identifier 1709 need not necessarily be known to the initiator once or forever when directing a communication to the receiver, by the same token, the unique initiator identifier 1603 need not necessarily be known to the receiver once or forever, nor is it needed to be indicated in any communication received from the initiator.

In cases where the unique receiver identifier 1709 is not known to an initiator, the receiver may choose to opt-out of future communication from the initiator. Upon receiving such a request for opt-out from the receiver, the server engine 1613 then sets an active flag 1705 to ‘N’ in a corresponding mapping record 1704 stored in 1701. From this point on, whenever the server engine 1613 receives a communication originated by the initiator, and intended to be directed to the receiver, as described in FIG. 16, the server engine 1613 checks for the setting of the active flag 1705. If the active flag is set to ‘N’, the server engine will not direct the communication to the receiver. It may be noted that the receiver may opt-out partially or completely from all communications originated by one or more initiators using their respective non-unique receiver identifiers which may point to one or more unique receiver identifiers as stored in the client record of the receiver available in the client repository 1606.

In cases such as the one depicted in 1706, wherein the receiver is only aware of the non-unique initiator identifier 1708, the initiator may choose to opt-out of future return communication from the receiver. Upon receiving such a request for opt-out from the initiator, the server engine 1613 then sets an active flag 1703 to “N” in a corresponding mapping record 1702 stored in the mapping repository 1701. From this point, whenever the server engine receives a communication originated by the receiver, and intended to be directed to the initiator, the server engine checks for the setting of the active flag 1703. If the active flag is set to ‘N’, then the server engine will not direct the communication to the initiator. It may be noted that initiator may opt-out partially or completely from all communications originated by one or more receivers using their respective non-unique initiator identifiers which may point to one or more unique initiator identifiers stored in the client record of the initiator available in the client repository 1606.

In another aspect, the present application may allow the users to enable a time-bound, opt-out feature whereby the user may restrict the receiving of the communications for a limited, specific period of time, thereby ensuring a greater control over the time of receiving the non-unique identifier-enabled communication. For example, a timer process may monitor time and automatically update the active flag fields.

The present application may also allow users to enable a channel-specific opt-out feature whereby the user may restrict the receiving of the communications to a limited number of specific channels, thereby ensuring a greater control over the channel and/or communications media through which the user prefers to receive a non-unique identifier-enabled communication. For example, another field in the mapping repository may include the desired channels for communication.

It will be appreciated by persons skilled in the art that various features of the application which are, for clarity, described in the context of separate embodiments may also be provided in combination in a single embodiment. Conversely, various features of the application which are described in the context of a single embodiment may also be provided separately or in any suitable combination. For instance, the user's client systems described herein may include just about any device through which a message may be sent.

In one aspect, the system and method of the present disclosure may work in a distributed environment. For example, more than one service provider servers directing the communications and hosting the mapping information may be dispersed in a network throughout the world, belonging to different entities. For instance, two different service providers, having their own databases, would interact. If a user A from the provider 1 sends communication such as an email through provider 2, provider 2 is enabled to link the communication by rerouting to provider 1 the handling of the communication.

Further, the communication may be performed independent of which service provider initially created the records pertaining to specific users. For example, once a user has created the user's records with a provider 1, the user may submit and initiate communication with any other provider, as they are interlinked, therefore, being independent of the provider the user originally used to create the user's records and non-unique identifiers. For instance, if a user creates bob@provider1.com, the user may also send to bob@provider2.com, and so on. The communication reaches the same person as provider 2 is enabled to contact provider 1 and provider 1 is enabled to handle the communication.

Details of distributed systems are well known. One such known distributed system is the DNS systems. Therefore, the details of the workings of the distributed systems will not be described in greater detail herein.

In another aspect, a third party may create the non-unique identifiers for the users, for example, initiators and receivers, for use for communicating.

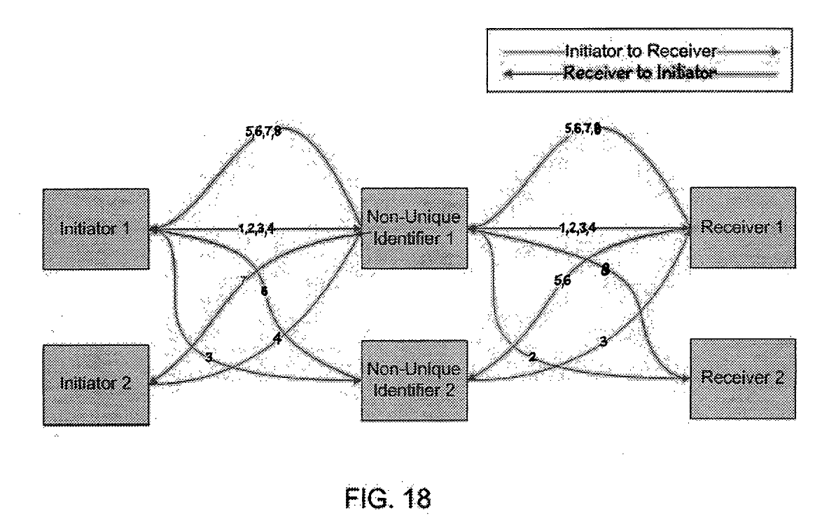

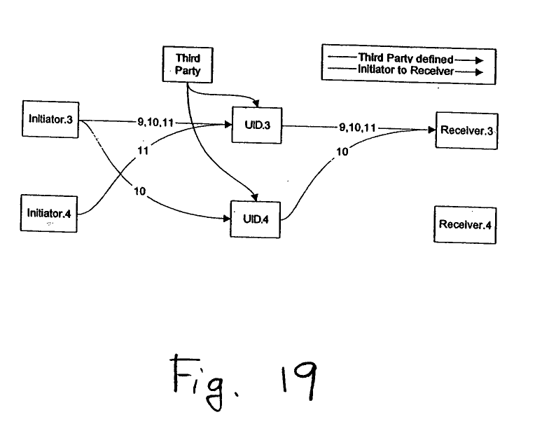

FIGS. 18-19 are examples of communication paths in one embodiment. As shown in communication path 1, an initiator user may define a single non-unique identifier to initiate communications to a receiver user. Communication path 2 shows that an initiator user may define a single non-unique identifier to initiate communications to a group of users. Communication path 3 shows that an initiator user may define multiple non-unique identifiers to initiate communications to a unique receiver user. Communication path 4 shows that multiple users may define an exact same non-unique identifier to initiate communications to a receiver user. Communication path 5 shows that a receiver may reply communications with one non-unique identifier to an initiator user. Communication path 6 shows that a receiver may reply with multiple non-unique identifiers to the same initiator user.

Communication path 7 shows that a receiver may reply with one non-unique identifier to a group of users. Communication path 8 shows that multiple users may reply with an exact same non-unique identifier to the same user. Communication path 9 shows that a third-party user, which may not be involved in the communications between an initiator user and a receiver user, may define a non-unique identifier for an initiator users to initiate communications to a receiver user. Communication path 10 shows that a third-party user, which may not be involved in communications between an initiator user and a receiver user, may define multiple non-unique identifiers to an initiator user to initiate communications to a receiver user. Communication path 11 shows that a third-party user, which may not be involved in communications between an initiator user and a receiver user, may define same non-unique identifiers for multiple initiator users to initiate communications to a receiver user.

The system and method of the present disclosure allows users to redefine communication identifiers, for example, users may define and use non-unique identifiers to initiate or reply communications to other users.

For instance, an initiator user may define a single non-unique identifier to initiate communications to a receiver user or a to a group of users. An initiator user may define multiple non-unique identifiers to initiate communications to a unique receiver user. Multiple users may define an exact same non-unique identifier to initiate communications to a receiver user.

In another aspect, receiver users may also use non-unique identifiers. For instance, a receiver may reply communications with one non-unique identifier to an initiator user. A receiver may reply communications with multiple non-unique identifier to the same initiator user. A receiver may reply communication with one non-unique identifier to a group of users. Multiple users may reply communication with an exact same non-unique identifier to the same user.

In yet another aspect, a third party user may use a non-unique identifier. For instance, a third-party user, which may not be involved in communications between an initiator user and a receiver user, may define a single non-unique identifier for an initiator users to initiate communications to a receiver user. A third-party user, which may not be involved in communications between an initiator user and a receiver user, may define multiple non-unique identifiers for an initiator user to initiate communications to a receiver user. A third-party user, which may not be involved in communications between an initiator user and a receiver user, may define an exact same non-unique identifiers for multiple initiator users to initiate communications to a receiver user.

In yet another aspect, the system and method of the present disclosure allows communication to be maintained even when unique identifiers for communications change. For instance, the system and method of the present disclosure allows for making changes to initiator's unique identifier. For example, an initiator user may add one or more initiator unique identifiers to initiate communications using previously created non-unique identifiers. An initiator may change his existing unique identifier into different one to initiate communications to receiver(s) using previously created non-unique identifier(s).

In yet another aspect, an initiator user may redefine existing receiver's non-unique identifier(s) pointing to the same receiver. For instance, after knowing a receiver has changed job, the initiator user may want to rename the receiver's non-unique identifier, for example, from bob.bank to bob.insurance.

In yet another aspect, an initiator user may redefine existing receiver's non-unique identifier(s) pointing to the different receiver. For instance, after knowing an initiator has changed job, the initiator user may want to rename the receiver's non-unique identifier, for example, from bob.bank to bob.insurance.

A request for the receiver's new unique identifier may be automatic, for example, when the user tries to use the service from a new email address, the service requests to register this new email address. In another aspect, a request for the receiver's new unique identifier may be through a third party, for example, when one wants to reach the receiver and get an error, he or the service may request an update.

In yet another aspect, when a receiver changes its unique identifier, all non-unique identifiers are updated accordingly without needing users to manually change the identifiers one by one. Further, when user A has a reference to a user B's unique identifier, user A may update user B's unique identifier.

In the present application, non-unique identifiers or non-unique receiver identifiers refer to identifiers that need not necessarily be unique, but can or may be unique. Further, it is possible to have a non-unique identifier or non-unique receiver identifier that is unique to a user. Thus, for example, both users A and B may each have defined a non-unique receiver identifier C. However, for user A, the receiver identifier C maps to receiver D; for user B, receiver identifier C maps to receiver E. As illustrated, receiver identifier C is non-unique in the communication system since both A and B use them to map to different receivers. However, receiver identifier C may be unique to user A. That is, user A may not have defined receiver identifier C to map to any other users or set of users. Similarly, receiver identifier C may be unique to user B.

In another embodiment, non-unique identifiers may be non-unique to a user. In this case, further information from a user or pointer may be used to determine the mapping of the non-unique identifiers to unique identifiers.

The system and method of the present application may be implemented and run on a general-purpose computer. The embodiments described above are illustrative examples and it should not be construed that the present application is limited to these particular embodiments. For example, although specific terms users, receivers, unique and non-unique receiver identifiers have been used in the description for clarity, it should be understood that a user may also take a role as a receiver of message, when for example a message is sent to the user. Likewise, a receiver may be in a role of a user who initiates or sends a message. Further, the functions of the service provider and/or the client and mapping repositories may be distributed across different platforms or systems. Thus, various changes and modifications may be effected by one skilled in the art without departing from the spirit or scope of the disclosure as defined in the appended claims.

We claim:

1. A method of directing communications in a communications network, comprising:
identifying a non-unique receiver identifier-enabled communication initiated by a user on a communications network;
retrieving a non-unique receiver identifier from the non-unique receiver identifier-enabled communication;
associating the non-unique receiver identifier with a unique receiver identifier using a record associated with the user; and
connecting the communication to the unique receiver identifier via the communications network.

2. The method of claim 1, wherein the user communicates with a receiver associated with the unique receiver identifier without transmitting the unique receiver identifier over the communications network.

3. The method of claim 1, wherein the user is enabled to receive a communication from another user without requiring a transmission of a unique identifier associated with the other user over the communications network.

4. The method of claims 1, wherein using a non-unique identifier renders the communication at least partially anonymous.

5. The method of claim 1, wherein the communication is initiated through an electronic mail client.

6. The method of claim 1, wherein the communication is initiated through a wireless device.

7. The method of claim 1, wherein the communication is initiated through a voice device.

8. The method of claim 1, wherein the communication is initiated through a web browser.

9. The method of claim 1, wherein the communication is received through an electronic mail client.

10. The method of claim 1, wherein the communication is received through a wireless device.

11. The method of claim 1, wherein the communication is received through a voice device.

12. The method of claim 1, wherein the communication is received through a web browser.

13. The method of claim 1, further including:
providing a service provider network residing on the communications network for performing the identifying, the retrieving, the associating, and the connecting.

14. The method of claim 1, further including:
allowing the user to create a non-unique receiver identifier associated with a receiver.

15. The method of claim 13, wherein the user initiates the communication via an electronic mail client.

16. The method of claim 13, wherein the user initiates the communication via a wireless device.

17. The method of claim 13, wherein the user initiates the communication via a voice device

18. The method of claim 13, wherein the user initiates the communication via a web browser.

19. The method of claim 1, further including:
allowing the user to change a unique identifier associated with a receiver; and
updating one or more records that point to the unique identifier.

20. The method of claim 1, wherein the user uses a plurality of non-unique identifiers to represent a single unique receiver.

21. The method of claim 1, wherein a plurality of unique users use a plurality of non-unique identifiers to represent a single common receiver.

22. The method of claim 1, wherein a plurality of unique users use a single non-unique receiver identifier to represent a single unique receiver.

23. The method of claim 1, wherein a plurality of unique users use a single non-unique receiver identifier to communicate with a plurality of unique receivers.

24. The method of claim 1, wherein a plurality of unique users uses a single non-unique receiver identifier to communicate with a group of plurality of related unique receivers.

25. The method of claim 1, wherein a user is enabled to create and use a non-unique receiver identifier regardless of one or more non-unique receiver identifiers created by other users.

26. The method of claim 1, wherein a non-unique receiver identifier created is distributed across a network of a plurality of service providers.

27. The method of claim 1, wherein the identifying, the retrieving, the associating, and the communicating is performed across a distributed network of multiple service providers.

28. The method of claim 1, wherein the communication is performed independent of a specific service provider in a distributed network.

29. The method of claims 1, further including:
allowing the user and a receiver to communicate with one another using only the non-unique receiver identifier.

30. The method of claim 1, further including:
allowing the user to disable further communication from a receiver associated with the non-unique receiver identifier.

31. The method of claim 1, further including:
allowing a receiver associated with the non-unique receiver identifier to disable further communication from the user.

32. The method of claim 1, wherein the connecting further includes allowing a receiver associated with the non-unique receiver identifier to communicate with the user using the non-unique receiver identifier and a non-unique identifier associated with the user.

33. The method of claim 1, further including:
determining if the user is a registered user, and if it is determined that the user is not a registered user, requesting the user to register.

34. The method of claim 33, further including:
if the user selects to register, creating a user repository storing one or more unique receiver identifiers and associated one or more non-unique receiver identifiers.

35. A program storage device readable by machine, tangibly embodying a program of instructions executable by the machine to perform method steps of directing communications in a communications network, comprising:
identifying a non-unique receiver identifier-enabled communication initiated by a user on a communications network; retrieving a non-unique receiver identifier from the non-unique receiver identifier-enabled communication;
associating the non-unique receiver identifier with a unique receiver identifier in record associated with the user; and
connecting the communication to the unique receiver identifier via the communications network.

36. The program storage device of claim 35, wherein the user communicates with a receiver associated with the unique receiver identifier without transmitting the unique receiver identifier over the communications network.

37. The program storage device of claim 35, further including:
determining if the user is a registered user, and if it is determined that the user is not a registered user, requesting the user to register.

38. The program storage device of claim 37, further including:
if the user selects to register, creating a user repository storing one or more unique receiver identifiers and associated one or more non-unique receiver identifiers.

39. A system for directing communications in a communications network, comprising:
a server engine operable to identify a non-unique receiver identifier-enabled communication initiated by a user on a communications network and operable to map a non-unique receiver identifier to a unique receiver identifier, the server engine further operable to direct communication to a receiver associated with the unique receiver identifier.

40. The system of claim 39, further including:
a client repository for storing user information including at least a client record identifier and one or more unique user identifiers;
a mapping repository for storing at least one or more non-unique receiver identifiers associated with the client record identifier and mapped to one or more unique receiver identifiers by an index to the user information stored in the client repository,
wherein the server engine maps the non-unique receiver identifier to the unique receiver identifier by retrieving the index in the mapping repository and indexing the unique receiver identifier in the client repository.

41. The system of claim 40, wherein the mapping repository further includes an active flag record associated with the non-unique receiver identifier for enabling or disabling communication to a receiver identified by the non-unique receiver identifier.

42. The method of claim 1, further including:
associating a unique identifier of the user to a non-unique identifier of the user; and
the connecting includes connecting the communication to the unique receiver identifier via the communications network and presenting the non-unique identifier of the user to the receiver, wherein the unique identifier of the user is not revealed to the receiver.

43. The program storage device of claim 35, further including:
associating a unique identifier of the user to a non-unique identifier of the user;
the connecting includes connecting the communication to the unique receiver identifier via the communications network and presenting the non-unique identifier of the user to the receiver, wherein the unique identifier of the user is not revealed to the receiver.

44. The system of claim 39, wherein the server engine is further operable to map a unique identifier of the user to a non-unique identifier of the user, wherein the server engine directs communication to a receiver associated with the unique receiver identifier and presents the non-unique identifier of the user without presenting the unique identifier of the user.

45. A method of directing communications in a communications network, comprising:
receiving a non-unique receiver identifier-enabled communication initiated by a user on a communications network; retrieving a non-unique receiver identifier from the non-unique receiver identifier-enabled communication;
determining from the non-unique receiver identifier-enabled communication whether the non-unique receiver identifier needs to be created; and
if it is determined that the non-unique receiver identifier needs to be created, retrieving a unique receiver identifier from the non-unique receiver identifier-enabled communication and creating a mapping record associating the unique receiver identifier with the non-unique receiver identifier.

46. The method of claim 45, further including:
connecting the communication to the unique receiver identifier via the communications network.

47. A program storage device readable by machine, tangibly embodying a program of instructions executable by the machine to perform method steps of directing communications in a communications network, comprising:
receiving a non-unique receiver identifier-enabled communication initiated by a user on a communications network;
retrieving a non-unique receiver identifier from the non-unique receiver identifier-enabled communication;
determining from the non-unique receiver identifier-enabled communication whether the non-unique receiver identifier needs to be created; and
if it is determined that the non-unique receiver identifier needs to be created, retrieving a unique receiver identifier from the non-unique receiver identifier-enabled communication and creating a mapping record associating the unique receiver identifier with the non-unique receiver identifier.

48. The program storage device of claim 47, further including:
connecting the communication to the unique receiver identifier via the communications network.

49. The method of claim 1, further including:
allowing user's unique-identifier to be modified; and
automatically updating the record associated with the user to map data in the record to the user's modified unique-identifier.

50. The method of claim 1, further including:
allowing the unique receiver identifier to be modified; and
automatically updating data associated with the unique receiver identifier to be associated with the modified unique receiver identifier.

51. The method of claim 1, further including:
automatically determining that the unique receiver identifier is no longer valid;
automatically requesting a new unique receiver identifier from users that communicate with a receiver associated with the unique receiver identifier;
if the new unique receiver identifier is received, automatically authenticating the new unique receiver identifier; and
if the new unique receiver identifier is authenticated, automatically updating data associated with the unique receiver identifier to map to the new unique receiver identifier.

52. A method of directing communications in a communications network, comprising:
receiving communication recipient's receiver identifier in a communication between a sender and a receiver, the receiver identifier being not necessarily unique;
determining communication recipient's unique identifier associated with the communication recipient's receiver identifier from one or more data records associated with at least one of the sender or the receiver; and
directing the communication to the communication recipient's unique identifier.
